(19) United States
(12) Patent Application Publication
(10) Pub. No.: US 2021/0362541 A1
(43) Pub. Date: Nov. 25, 2021

(54) THERMOCHROMIC WHEEL LUG NUT DEVICE

(71) Applicant: Ifor C. Davies, Oakville (CA)

(72) Inventor: Ifor C. Davies, Oakville (CA)

(21) Appl. No.: 17/323,703

(22) Filed: May 18, 2021

Related U.S. Application Data
(60) Provisional application No. 63/027,185, filed on May 19, 2020.

(51) Int. Cl. B60B 3/16; G01K 1/02; G01K 1/14

(52) U.S. Cl. CPC B60B 3/165; G01K 1/02; B60B 2320/52; B60B 2900/521; G01K 1/14

(57) ABSTRACT

A wheel lug nut locking attachment, lug nut position locator device, or lug nut locking device is provided, wherein the attachment or devices include a thermochromic material which provides an indication of excess heat generation in the wheel assembly of a tractor trailer. A warning system to alert an operator of the present of excess heat in the wheel assembly is provided. In a preferred embodiment, the device also acts to lock a wheel lug nut to an adjacent wheel lug nut, so as to prevent or reduce rotation of the wheel lug nut. A plurality of thermochromic lug nut locking devices can be fitted to a single wheel so that all of the lug nuts are operatively locked to an adjacent lug nut. The resulting locking system can be rapidly installed on each lug nut on all wheels, so as to provide improved vehicle safety aspects.

### CROSS-REFERENCE TO RELATED APPLICATIONS

This application claims priority to provisional U.S. Application No. 63/027,185 filed 19 May 2020, which is incorporated herein by reference.

### FIELD OF THE INVENTION

The present invention relates to the field of wheel lug nuts, and in particular, relates to a safety device that is used to monitor the temperature of the wheel assembly of a vehicle, additionally relates to a device for locking the wheel lug nuts in place and/or indicating rotational movement of a wheel lug nut.

### BACKGROUND OF THE INVENTION

In large vehicles such as trucks and buses, and especially tractor-trailer assemblies, it is possible for loosening wheels, and other problems to go unnoticed. Detection of loosening wheels, and loosening lug nuts, is difficult to observe even when the trailer is stationary. When in motion, the problem is exacerbated by the distance between the operator and the wheels of the vehicle so that detection of a loosening wheel is not readily observed.

A particularly significant issue relates to the inadvertent loosening of the wheel lug nuts which are used to hold the wheel hub in place. Loosening of these nuts can cause damage to the wheel assembly, and in a worst case scenario, can result in the loss of the wheel or wheel assembly from the vehicle. This loosening can be as a result of improper tightening, for example, but can also be caused by other causes, such as vibration in the tire/wheel assembly, temperature changes, or the like. Also, contaminants lodged between the lug, the wheel hub surface, and the like, can prevent proper seating of the wheel which can lead to loosening of the lug nut when the contaminant breaks free. As such, there are a variety of reasons why a wheel lug nut will loosen over time. However, even with visual inspections when the trailer is stopped, the initial stages of a loosening wheel lug nut are difficult to observe.

Numerous devices have been suggested to monitor and/or prevent vehicle wheel lug nuts from loosening. In one option, the device is a plastic disk having an arrow shape which is fitted over each wheel lug nut. Any movement of a lug nut will cause the arrow direction to change. While this is useful for visually checking the lug nut, it does not provide any mechanism to check or abate movement of the lug nut, and thus, the wheel can still become free.

Other devices providing an interlocking ring of plastic clips that can be positioned around all of the lug nuts, so as to lock the lug nuts in place, and lock to adjacent clips. When the trailer is stationary, the ring of plastic clips can be checked to determine whether the clips on the ring have moved with respect to each other. During use, the interlocking feature assists in preventing rotational movement of the lug nuts.

However, this approach requires that a covering/attachment ring be fitted to each lug nut and then interlocked with each adjacent lug nut assemblies. This can take an excessive amount of time. Further, fitting of the last assembly to the last lug nut can be difficult, and thus, forming the interlocking ring can prove to be difficult.

One particularly useful device for locking the lug nuts in place, and for providing a visual indication of lug nut loosening is found in my earlier US patent published as U.S. Pat. No. 8,708,627. A particularly useful feature of that device was the use of a flexible, resilient connection section having a concertina-like structure, which allowed relative movement of first and second planar sections at the end of the device, which were attached to adjacent wheel lug nuts. This approach essentially prevented the lug nuts from loosening, and provided clear evidence of any loosening, should that occur.

While this addresses the issue of lug nut loosening, another difficulty encountered with larger vehicles, is excessive heat generation in the wheel assembly caused by, for example, brake failure, brake wear, excessive brake use, bearing failure, or other such causes. These heat generation issues are also difficult for the vehicle operator to visually identify prior to damage to the affected portions of the wheel assembly. To address this issue, the use of thermochromic devices have been proposed to identify excess heat build-up in the wheel assembly. Typically, these are used as self-adhesive, thermochromic tabs which are affixed to the wheel hub, and change colour when a given hub assembly temperature is reached. The colour change on these tabs is typically non-reversible and thus, the devices provide only a one-time indication of a heat generation problem. Other approaches include bolts with thermochromic inserts, and the like. Examples of these types of devices are shown in, for example, U.S. Pat. No. 3,569,695 (McLean), U.S. Pat. No. 3,877,411 (MacDonald), U.S. Pat. No. 7,845,217 (Dodd), 2002/0185052 (Kelly Jr. et al.), 2008/0290722 (Koschinat), 2012/0032793 (Sonzala et al.), and 2016/0273581 (Wallmeier et al.). While these devices provide some assistance in this area, it would still be beneficial to provide a simpler, more easily used device, which would provide improved heat generation information to the vehicle operator.

### SUMMARY OF THE INVENTION

Accordingly, it is a principal advantage of the present invention to provide a thermochromic wheel lug nut attachment which provides an indication of excess heat generation in the wheel assembly.

It is another principle advantage of the present invention to provide a thermochromic wheel lug nut position indicator device, which preferably provides an indication of any rotational movement, or loosening, of the wheel lug nut, while also providing an indication of excess heat generation in the wheel assembly.

It is a further principle advantage of the present invention to provide a thermochromic wheel lug nut locking device which reduces, and aids in resisting any rotational movement of the wheel lug nut, while also providing an indication of excess heat generation in the wheel assembly.

It is a still further advantage of the present invention, to provide such a thermochromic wheel lug nut attachment, position indicator or locking device which is low cost, easily used, and easily checked by the driver, operator, or the like.

These advantages set out hereinabove, as well as other objects and goals inherent thereto, are at least partially or fully provided by the thermochromic wheel lug nut attachment, position indicator or locking device of the present invention, as set out herein below.

Thus, the present invention provides a vehicle wheel lug nut attachment, position indicator device, or lug nut loosening prevention device, which includes a visual temperature indication system, such that when said attachment or device is fitted to at least one vehicle wheel lug nut in a wheel assembly, it is thermally connected to the wheel lug nut, and thereby provides a visual indication of excess heat generation in the wheel assembly.

Preferably, in the practice of the present invention, the wheel lug nut attachment or device is configured for attachment to at least one wheel lug nut, and all or part of the attachment or device includes a thermochromic section as said visual temperature indication system.

Thus, in a first preferred exemplary implementation, the present invention provides a thermochromic wheel lug nut attachment comprising a first member having an opening configured to be friction fitted around a lug nut, and thermally connected thereto, and wherein, all or a portion of said first member includes a thermochromic material which is thermally connected to said lug nut.

In a second preferred exemplary implementation, the present invention provides a thermochromic wheel lug nut position indicator device, comprising a first member having an opening configured to be friction fitted around a lug nut, and additionally comprising a position indicator on, or as part of said first member, and wherein all or a portion of said first member includes a thermochromic material which is thermally connected to said lug nut.

The position indicator device can simply include a simple mark, as a marker, on the first member, which can be used to point in a specified direction, or to point made on the wheel assembly. Movement of the marker indicates that the lug nut has moved, and thus, may be loosening. The device might also include an integral indicator section which can be used as the position indicator. This is preferably in the shape of an arrow, or the like, in order to indicate the alignment of the device on the lug nut, and/or lug nut movement thereof.

In a third preferred exemplary implementation, the present invention provides a thermochromic wheel lug nut locking device comprising a first member having an opening configured to be friction fitted around a lug nut, and additionally comprising a lug nut locking device to hold a lug nut in place. The locking device can include any of the known lug nut locking systems which are described in the prior art.

In a preferred embodiment though, the thermochromic lug nut locking device comprises a locking member having a first planar section at one end of the locking member, a second planar section at an opposite end of the locking member, and a flexible, resilient connection section between said first and second planar sections, which connection section allows relative movement of the first and second planar sections, and wherein each of said first and second planar sections has an opening configured to be friction fitted around separate, and preferably adjacent, lug nuts, and wherein, all or a portion of said locking member includes a thermochromic material which is thermally connected to one or more lug nuts.

In one preferred embodiment, the said first and second planar sections, and said flexible, resilient connection section, are all substantially flat and are co-planar so as to form an essentially flat, planar device.

Preferably, the connection section allows movement of said first and second planar sections within the plane of the member, and most preferably, the flexible, resilient connection section has a concertina-like shape that allows the connection section to be compressed or expanded within the plane of the flat member.

Preferably, the thermochromic wheel lug nut locking device of the present invention includes two openings configured to be fitted around two adjacent wheel lug nuts. However, the device can also include a plurality of planar sections with openings, all separated by flexible, resilient sections, can be provided, in series, so that the device is configured to be fitted around three or more lug nuts.

While in one example, a single locking device be fitted in series around all of the lug nuts in a wheel assembly, preferably, the number of openings included in the device is less than 6, and more preferably less than 4. Most preferably, however, the number of lug nut openings is two so that each wheel lug nut can be operatively connected to one adjacent wheel lug nut.

As such, in a further aspect, the present invention also provides a wheel assembly which wheel assembly comprises a plurality of wheel lug nuts, and at least one thermochromic attachment, position indicator device or lug nut locking device as described hereinabove, wherein at least one, and preferably two or more lug nuts, are operatively thermally connected to said thermochromic attachment, position indicator device or lug nut locking device.

A combination of lug nut attachments, lug nut position indicators, and lug nut locking devices might be used. This can include combinations with various lug nut attachments and devices from the prior art. However, in the practice of the present invention, at least one, and preferably all of the wheel lug nuts in the wheel assembly are connected to thermochromic attachments, lug nut position indicator devices, and or lug nut locking devices.

In a further aspect, the present invention also provides a method for reducing the amount of rotational movement of at least one lug nut on a wheel assembly, by placing one or more thermochromic lug nut locking devices of the present invention, on at least one lug nut. Preferably, the method includes the approach wherein all lug nuts of a wheel assembly are each connected to a lug nut locking device of the present invention, and in particular, a thermochromic lug nut locking device which comprises a locking member having a first planar section at one end of the locking member, a second planar section at an opposite end of the locking member, and a flexible, resilient connection section between said first and second planar sections, which connection section allows relative movement of the first and second planar sections, and wherein each of said first and second planar sections has an opening configured to be friction fitted around separate lug nuts, and wherein, all or a portion of said locking member includes a thermochromic material which is thermally connected to one or more lug nuts.

Preferably, all of the lug nuts of a wheel assembly are each connected to lug nut locking devices.

In a still further aspect, the present invention also provides a wheel lug nut position indicator system, comprising placing one or a plurality of wheel lug nut position indicator devices on a plurality of lug nuts on a wheel assembly, and preferably, on all of the lug nuts of a wheel assembly, wherein at least one lug nut position indicator device is the thermochromic lug nut position indicator device of the present invention.

In a yet still further aspect, the present invention also provides a wheel lug nut locking system comprising placing a plurality of locking devices of the type described herein, around the lug nuts of a wheel assembly. Preferably, each lug nut on the wheel assembly is fitted with a locking device of the present invention. For example, in a ten lug nut wheel, 5 two-opening locking devices would be used so that each wheel lug nut is connected to a locking device, and operatively connected to one adjacent wheel lug nut. In a preferred embodiment, one or more of the locking devices used, is the thermochromic wheel lug nut locking device of the present invention.

### DETAILED DESCRIPTION OF THE INVENTION

In the present application, the terms “lug nut” or “wheel lug nut” refers to the nut which is used to hold the wheel in place on, for example, a tractor trailer wheel assembly, by attachment of the lug nut to a threaded stud on the wheel assembly. The wheel lug nuts of most interest in the practice of the present invention are lug nuts on the wheels of larger vehicles, such as trucks, buses, tractor-trailers, and the like. However, the skilled artisan will be aware that lug nuts, or similar types of nuts, can be used in a wide variety of application. Accordingly, while the present application is described herein with particular reference to the tractor trailer industry, the skilled artisan would be aware that the present application is equally applicable in other applications where relative rotational movement of tightening nuts, is desired. This could include flange nuts, and other connector nuts, or the like, which might be subjected to excess heat.

Also, in the present application, the term “attachment” refers primarily to a product that can be attached to a wheel lug nut. The phrase “position indicator device” refers to a wheel lug nut device which is fitted to a single lug nut, and includes a marker to indicate alignment or movement of the device. The phrase “lug nut locking device” refers to devices which are attached to preferably two or more lug nuts, and which devices act to prevent or minimize movement of the lug nut.

The attachment or devices of the present invention can be made of any suitable materials, or any suitable combination of materials. This includes plastic or metal materials, or combinations thereof. Most preferably, however, the attachment or devices are manufactured from plastic, by, for example, injection molding or the like. Suitable plastics include thermoplastic materials such as polyethylene, polypropylene, or the like. Highly visible plastics are preferred.

Preferably, the thermochromic material is incorporated into the plastic material so that the entire attachment or device includes the thermochromic feature.

The plastic material selected should also provide suitable properties for such lug nut attachment, position indicator or locking devices, at a suitable temperature range of, for example, −40° C. to +50° C., or the like. However, it should be noted that the devices should also still be able to provide suitable short-term functionality at the temperatures of interest in the present invention as lug nut position indicators or lug nut locking devices, at the higher temperatures which will be encountered when there is excess heat generation in the wheel assembly. These higher temperatures can be up to 120° C., or even higher, where some softening of the plastic might occur, but the plastic will retain suitable physical properties to act as the wheel lug nut attachments, lug nut position locator devices, or lug nut locking devices, of interest in the present invention.

The openings on the attachment, position indicator device, or locking device preferably each include a series of “teeth” which are adapted to fit around and hold against the “shoulders” on the exterior of the lug nuts, and thus provide a friction fit. Typically, the size of the opening, and the number of teeth utilized, will be dependent on the size and spacing of the lug nuts.

When present, the flexible, resilient connection section is sufficiently rigid so as to assist in minimizing movement of the lug nuts, but is still flexible enough to allow the device installer to flex the device in the plane of the device, or outside of the plane of the device, in order to fit the openings over adjacent lug nuts.

The thermochromic material is selected from any suitable thermochromatic materials for the temperature ranges encountered. Typically thermochromatic materials are provided as inks, dyes, such as leuco dyes which may be microencapsulated, pigments, liquid crystals, and the like. These materials are well known in the art of thermochromism.

Preferably, the thermochromic material is used to change the colour so as to be clearly visible (e.g. from white to black, invisible to coloured, or the like). The use of contrasting colours is therefore preferred. Brightly coloured thermochromic materials can also be used, for high visibility.

In one embodiment, the thermochromic material can be applied to the surface of the wheel lug nut devices of the present invention, as an ink, paint or coating. More preferably though, the thermochromic material is included as part of the plastic material, and preferably as part of the polymer matrix which is used to make the wheel lug nut devices of the present invention.

Also, while the thermochromic material can undergo a single-use, non-reversible colour change once the desired temperature threshold is met, preferably the temperature-caused colour change is reversible over time. This is particularly desirable in the situation where the thermochromic material is part of the polymer matrix, and the extrusion temperature of the plastic material is above the desired threshold temperature of the thermochromic material used.

Preferably, the threshold temperature for initiating the color change in the thermochromic material used is a temperature of above 60° C., more preferably, above 90° C., and still more preferably, above a temperature of 120° C. Additionally, in some situations, such as when the thermochromic material is applied as a coating, different thermochromic materials can be applied in order to provide a more specific indication of the temperature to which the thermochromic wheel lug nut attachment, position indicator device, or locking device of the present invention, were exposed.

It should also be noted that the excess heat generated in the wheel assembly, such as by a worn brake, or by excessive use of the brake, (which brake temperatures can easily approach 250° C., or even higher), is easily transmitted through the threaded metal studs used for holding the vehicle wheels in place. This heat is also easily transferred to the threaded metal lug nuts which are connected to the studs. As a result, the lug nuts are heated from the wheel assembly excess heat. In turn, the thermochromic wheel lug nut attachment and devices of the present invention are attached to, and thermally connected to, the heated lug nuts. Depending on the temperature of the lug nuts, and the time of exposure to the lug nut heat, when required, the thermochromic material in the lug nut device will undergo a colour change from one colour to another, and thus provide an indication that the wheel assembly, has generated excessive heat.

Even when plastic is used as the material to produce the wheel lug nut device of the present invention, heat from the lug nut will still pass through the device. Areas closest to the lug nut will change colour sooner than areas further away from the lug nut. This gradient acts to provide an indication of the amount of excess heat generation. For example, a small amount of excess heat might only cause the thermochromic material in the immediate vicinity of the lug nut to change colour, while the rest of the wheel lug nut device will remain the original, low temperature colour. Increased heat will cause more of the wheel lug nut device to change colour, and thus provide more of an alert to the driver or operator. Should the entire wheel lug nut device change colour, the operator will be alerted to a significant heat generation issue in the wheel assembly.

In a thermochromic wheel lug nut locking device attached to two adjacent lug nuts, the colour change will first occur in the area nearest to the two lug nuts. Increased temperatures or exposure times will also result in a gradient colour change in the connecting section of the device, located between the openings fitted around the lug nuts. This gradient in the connecting section, can also provide an indication of the amount of excess heat being generated.

### BRIEF DESCRIPTION OF THE DRAWINGS

Embodiments of this invention will now be described by way of example only in association with the accompanying drawings in which:

FIGS. 1a, 1b and 1c show front views of three different options of thermochromic wheel lug nut attachments or devices included as part of the present invention;

FIGS. 2a, 2b and 2c are side views of the attachments or devices from FIGS. 1a, 1b, and 1c, respectively:

FIGS. 3a, 3b and 3c show front views of the three attachments or devices from FIGS. 1a, 1b and 1c, respectively, mounted on lug nuts;

FIGS. 4a, 4b and 4c show fronts views of the wheel lug nut device from FIGS. 1a, 1b and 1C, respectively, which devices have been exposed to excess heat levels which have been generated from the wheel assembly;

FIG. 5 shows a front view of a wheel mounted on a wheel assembly which has been fitted with the locking devices from FIG. 3c;

FIG. 6 shows a front view of an alternative wheel mounted on a wheel assembly;

FIG. 7 shows an alternative arrangement for the wheel lug nut locking device of the present invention, on a wheel assembly;

FIG. 8 shows a perspective view of an alternative embodiment of the thermochromic lug lock device of the present invention; and

FIG. 9 shows a front view of a further embodiment of the thermochromic lug lock device of the present invention.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following drawings in which presently preferred embodiments of the invention will be illustrated by way of example only.

In the drawings, like reference numerals depict like elements.

It is expressly understood, however, that the drawings are for the purpose of illustration and description only and are not intended as a definition of the limits of the invention. Also, unless otherwise specifically noted, all of the features described herein may be combined with any of the above aspects, in any combination.

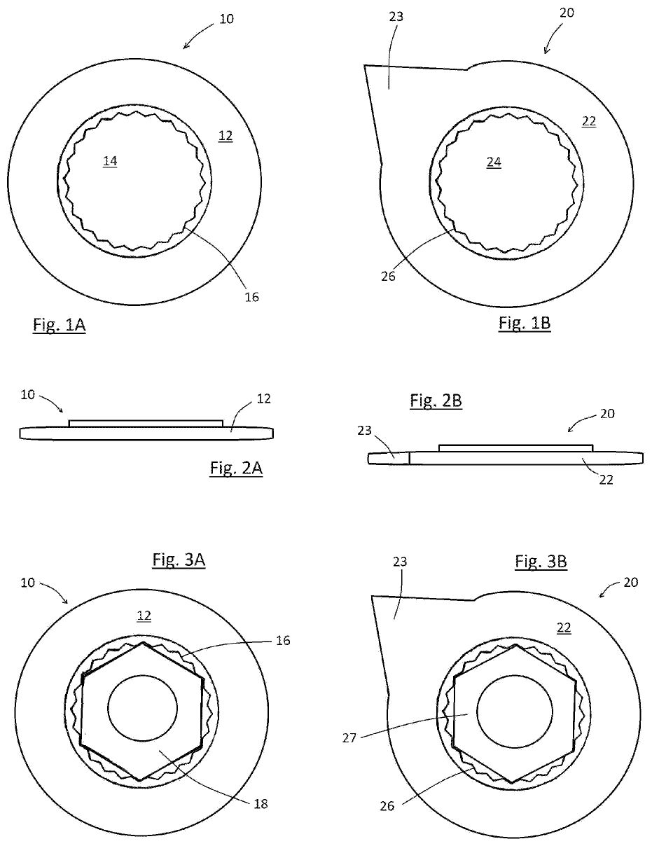

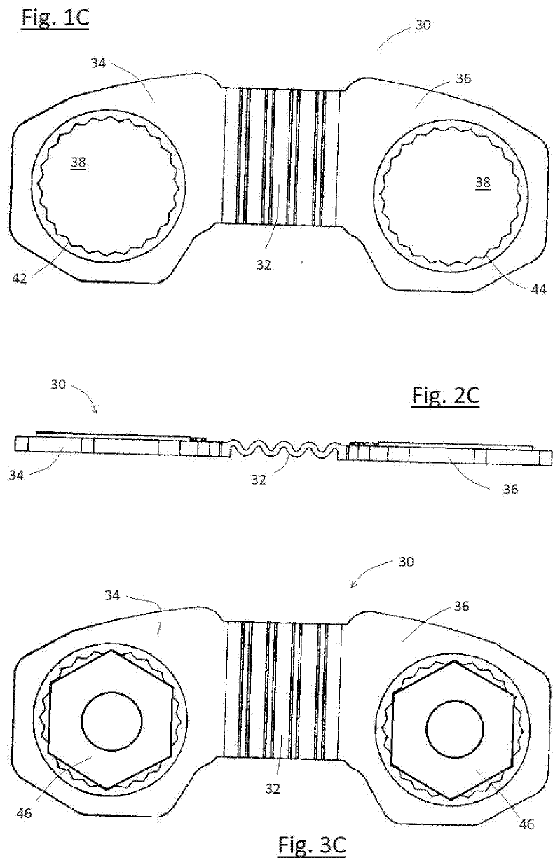

Referring to FIGS. 1a and 2a, front and side views of a first embodiment of a thermochromic wheel lug nut attachment 10 are shown, in which an essentially round, planar member 12 is shown having an opening 14. Around the perimeter of opening 14 are a series of “teeth” 16, which are provided to engage the shoulders of a lug nut.

In FIG. 3a, attachment device 10 is fitted to a single lug nut 18.

A front view and side view of a second embodiment of a thermochromic wheel lug nut position indicator device 20 is shown in FIGS. 1b and 2b. Again, device 20 has a planar and generally circular shaped member 22 but also has an integral position indicating marker 23, in the shape of an arrow. Device 20 also includes a single opening 24, and around the perimeter of opening 24 are a series of teeth 26, which teeth are provided for a friction fit to the shoulders of a lug nut.

In FIG. 3b, device 20 is fitted to a single lug nut 27. Any movement of lug nut 27 will result in movement of the integral position indicating marker 23.

A front and side view of a third embodiment of a thermochromic wheel lug nut locking device 30 is shown in FIGS. 1c and 2c. Device 30 is a generally planar shaped member, and includes two planar end sections 34 and 36 each having an opening 38 and 40. Around the perimeter of openings 38 and 40 are a series of teeth 42 and 44, which teeth are provided for a friction fit to the shoulders of a lug nut. Planar end sections 34 and 36 are separated by a flexible, connection section 32. Connection section 32 is made flexible by providing a concertina-like section which permits relative movement of planar end sections 34 and 36 in the plane of device 30. Movement in and out of the plane of device 30 by bending of connection section 32 is also possible and permitted.

In FIG. 3c, device 30 is fitted to two adjacent lug nuts 46. Movement of either of lug nuts 46 is prevented or minimized by the resistance to movement created by device 30.

In all of FIGS. 1, 2 and 3, the attachment 10 and devices 20 and 30, are made of plastic, and include a reversible thermochromic material which has been mixed into the plastic during the production process. As such, all of attachment 10 and devices 20 and 30 include the thermochromic material throughout the entire attachment or device.

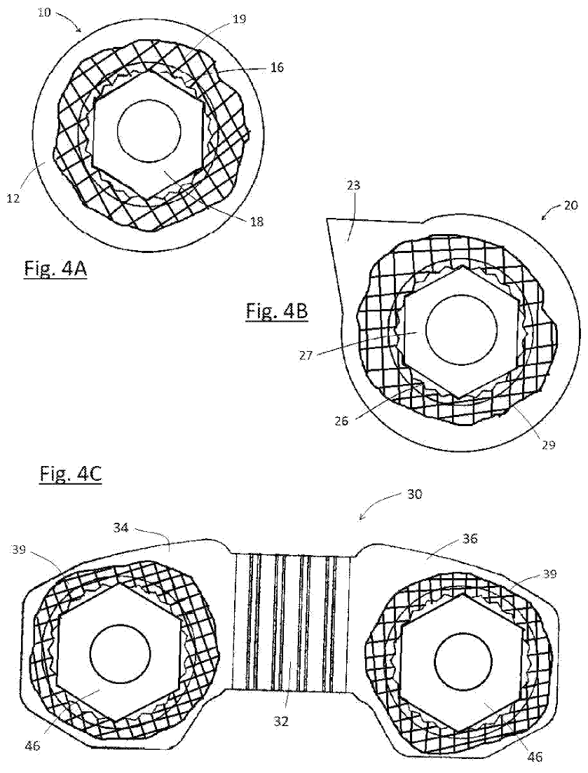

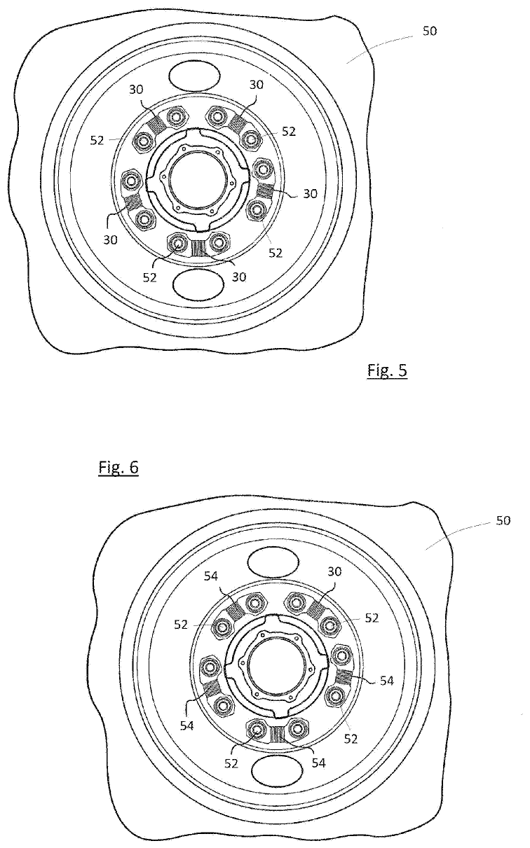

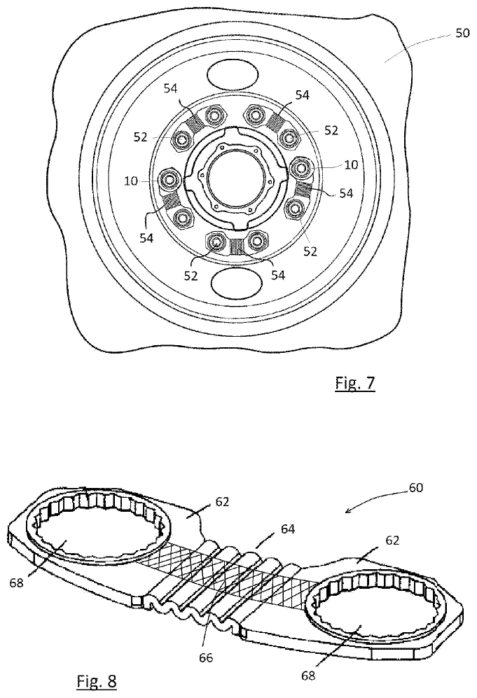

In FIGS. 4a, 4b, and 4c, the thermochromic wheel lug nut attachment and devices of FIGS. 3a, 3b and 3c (10, 20 and 30, respectively) are again shown, but in this series of figures, lug nuts 18, 27 and 46, have all been subjected to excess heat. This has caused a change in colour of part of attachment 10 and devices 20 and 30, in the areas nearest to the lug nuts. This colour change is indicated in attachment 10, and devices 20 and 30, by hashing 19, 29 and 39, respectively. As can be seen, a portion of attachment 10 and devices 20 and 30, in the vicinity of lug nuts 18, 27 and 46, have all changed colour, to indicate that the wheel lug nuts (and their related brake hubs and/or wheel assemblies) have been subjected to excess heat.

In use, the thermochromic properties of attachment 10 allows the user to see evidence of excess heat in the brake hub and/or wheel assembly. In device 20, the movement of arrow position indicator 23 also allows for the operator to see evidence of the rotation of a lug nut 27. In device 30, the lug nuts locking device also prevents or minimizes movement of the lug nuts.

In FIG. 5, a portion of a wheel hub assembly 50 is shown having ten lug nuts 52 which are used to hold the wheel hub 50 on a trailer wheel axle assembly in the manner known within the industry. Five thermochromic lug nut locking devices 30, as shown in FIG. 3c, have each been installed on two lug nuts 52, creating five sets of two lug nuts. As a result, each of the ten lug nuts 52 is operatively connected to one adjacent lug nut 52. Fitment of the thermochromic lug nut locking devices 30, is similar to that described in respect of the lug nut locking devices shown in U.S. Pat. No. 8,708,627. The thermochromic lug nut locking devices 30 provide protection from loosening of each of the ten lug nuts 52 on wheel hub 50, and also provide an indication of whether excess brake hub, or wheel assembly temperatures have been recently encountered.

In FIG. 6, a portion of the same wheel hub assembly 50 is shown having ten lug nuts 52 which are used to hold the wheel hub 50 on a trailer wheel axle assembly in the manner known within the industry. Again, five lug nut locking devices have been installed on 5 sets of two lug nuts 52. Each of the ten lug nuts 52 is thus operatively connected to one adjacent lug nut 52. In this case, four of the lug nut locking devices, are simple locking devices 54 as shown in U.S. Pat. No. 8,708,627, and fitment of those devices is described in the earlier patent. The fifth lug nut locking device is the thermochromic lug nut locking device 30 from FIG. 3c, and is installed in a similar manner to the earlier devices. In this example, the combination of the two types of lug nut locking devices provides protection from loosening of each of the ten lug nuts 52 on wheel hub 50, while thermochromic lug nut device 30 also acts as an indication of whether excess brake hub, or wheel assembly temperatures have been recently encountered.

With respect to FIGS. 5 and 6, as was described in U.S. Pat. No. 8,708,627, in use, any loosening of a wheel lug nut 52 is initially prevented by the resistance to movement by the resilient nature of locking device 30 or 54. As such, the amount of rotational movement of the lug nut 52 is minimized. However, should the lug nut 52 continue to loosen, it will ultimately deform the shape of concertina-like section 32, so as to be visible by the operator on inspection. Short of a catastrophic failure of flexible section 32, the locking devices 30 and 54 act to prevent complete loosening of lug nuts 52, even in situations where some minor loosening of a lug nut 52 has occurred. Since the lug nut 52 is prevented from any significant rotation, the likelihood of a total release of lug nut 52 from wheel hub 40 is essentially eliminated.

In FIG. 7, a further alternative embodiment of the arrangement of the lug nut locking devices is shown on wheel assembly 50. In this embodiment, five prior art lug nut locking devices 54 are provided to lock ten lug nuts 52 into five sets of two lug nuts. In this embodiment though, a single thermochromic attachment 10 is placed on two lug nuts 52, in addition to lug nut locking devices 54. In this configuration, the vehicle operator is provided the locking of all lug nuts, and is also provided with a thermochromic indication of excess temperature.

It is thus clear that combination of attachments and devices can be used. In one preferred approach, instead of attachments 10, five additional thermochromic lug nut locking devices 30 can be placed between the prior art locking devices 54, and attached to lug nuts 52. In this approach, each lug nut 52 is connected to a standard lug nut locking device 54 in a first direct, and to a thermochromic lug nut locking device 30, in a second direction. As such, each lug nut 52 is locked to two adjacent lug nuts.

In FIG. 8, a perspective view of an alternative embodiment of the thermochromic lug nut locking device of the present invention is shown. Device 60 is similar to the prior art devices shown in U.S. Pat. No. 8,708,627, and has two end sections 62 with a flexible connecting section 64, between the two ends. In this embodiment, a band 66 of thermochromic ink has been applied as a coating to the middle of connecting section 64, and extends from one opening 68 in one end section 62 to an opening 68, in the other end section 62.

In use, if a lug nut were to be exposed to excess heat, the thermochromic ink in band 66 would change colour, beginning in the area nearest to the heated lug nut. Depending on the length of time, and the temperature, the colour change effect would travel along band 66, and thus create a gradient that would be representative of the amount of excess heat found in the lug nut, or lug nuts.

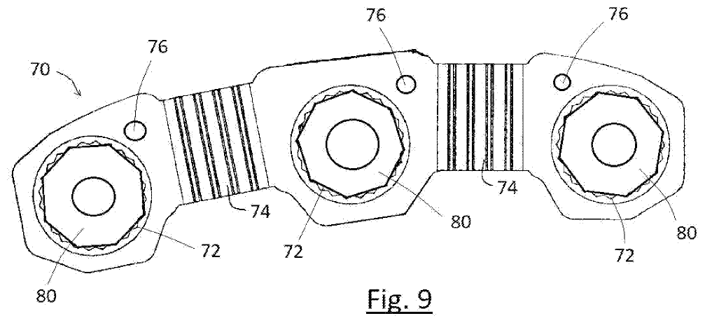

In FIG. 9, a front view of a further embodiment of the present invention is shown, wherein a thermochromic lug nut locking device 70 is shown having three openings 72, and two flexible connecting sections 74 located between the openings. In use, the three openings are placed over three lug nuts 80, which are positioned in series around a wheel hub (not shown). Also, in this embodiment, a small coating of a thermochromic material 76 has been applied to device 70 in the vicinity of each opening 72. During inspection of the device by an operator, a colour change in any or all of the thermochromic material coatings 76, would be an indication of excess temperature in a lug nut.

While three openings are shown in FIG. 9, it will be clear that the number of openings per lug nut locking device can vary, as previously described.

The locking devices of the present invention are preferably made of a bright, highly visible plastic material which allows them to be easily seen, even under low lighting conditions. This allows the condition of the wheel lug nuts to be easily and rapidly checked on a regular basis. Again, the thermochromic material used preferably causes the colour of the attachment or device (or coating) to preferably change to a contrasting colour.

Thus, it is apparent that there has been provided, in accordance with the present invention, a thermochromic lug nut attachment, position indicator device and lug nut locking device, which fully satisfies the goals, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps. Further, the invention illustratively disclosed herein suitably may be practiced in the absence of any element which is not specifically disclosed herein.

Moreover, words such as “substantially” or “essentially”, when used with an adjective or adverb is intended to enhance the scope of the particular characteristic; e.g., substantially planar is intended to mean planar, nearly planar and/or exhibiting characteristics associated with a planar element.

Further, use of the terms “he”, “him”, or “his”, is not intended to be specifically directed to persons of the masculine gender, and could easily be read as “she”, “her”, or “hers”, respectively.

Also, while this discussion has addressed prior art known to the inventor, it is not an admission that all art discussed is citable against the present application.

What is claimed is:

1. A vehicle wheel lug nut attachment, lug nut position indicator device, or lug nut loosening prevention device, which includes a visual temperature indication system such that when said attachment or device is fitted to at least one vehicle wheel lug nut in a wheel assembly, said visual temperature initiation system is thermally connected to the wheel lug nut, and thereby provides a visual indication of excess heat generation in said wheel assembly.

2. A vehicle lug nut attachment or device as claimed in claim 1, wherein said attachment or device is configured for attachment to at least one wheel lug nut, and all or part of the attachment or device includes a thermochromic material as said visual temperature indication system.

3. A vehicle lug nut attachment as claimed in claim 1, wherein said attachment comprises a first member having an opening configured to be friction fitted around a lug nut, and thermally connected thereto, and wherein, all or a portion of said first member includes a thermochromic material which is thermally connected to said lug nut.

4. A device as claimed in claim 1, wherein said lug nut position indicator device, comprises a first member having an opening configured to be friction fitted around a lug nut, and additionally comprising a position indicator on, or as part of, said first member, and wherein all or a portion of said first member and/or said position indicator includes a thermochromic material which is thermally connected to said lug nut.

5. The device as claimed in claim 4 wherein said position indicator device includes a mark on said first member, which can be used as a marker to point in a specified direction.

6. The device as claimed in claim 4 wherein said device includes an integral indicator section as the position indicator.

7. The device as claimed in claim 6 wherein said integral indicator section is in the shape of an arrow.

8. The device as claimed in claim 1 wherein said lug nut locking device comprising a first member having an opening configured to be friction fitted around a lug nut, and additionally comprising a lug nut locking device to hold a lug nut in place.

9. The device as claimed in claim 8 wherein said lug nut locking device comprises a locking member having a first planar section at one end of the locking member, a second planar section at an opposite end of the locking member, and a flexible, resilient connection section between said first and second planar sections, which connection section allows relative movement of the first and second planar sections, and wherein each of said first and second planar sections has an opening configured to be friction fitted around separate lug nuts, and wherein, all or a portion of said locking member includes a thermochromic material which is thermally connected to one or more lug nuts.

10. The device as claimed in claim 9 wherein said first and second planar sections, and said flexible, resilient connection section, are all substantially flat and are co-planar so as to form an essentially flat, planar device.

11. The device as claimed in claim 9 wherein said openings on said first and second planar sections of said locking member are configured to be fitted around adjacent lug nuts.

12. The device as claimed in claim 9, wherein said flexible, resilient connection section has a concertina-like shape that allows the connection section to be compressed or expanded within the plane of the flat member.

13. The device as claimed in claim 9 comprising a plurality of planar sections with openings, all separated by flexible, resilient connection sections, in series, so that said device is configured to be fitted around three or more lug nuts.

14. The vehicle wheel lug nut attachment or devices as claimed in claim 1 wherein said attachment or devices are made of plastic.

15. The vehicle wheel lug nut attachment or devices as claimed in claim 14 wherein said attachment or devices are made of a highly visible plastic.

16. The vehicle wheel lug nut attachment or devices as claimed in claim 1 wherein said thermochromic material is applied to the surface of said attachment or devices, as an ink, paint or coating.

17. The vehicle wheel lug nut attachment or devices as claimed in claim 14, wherein said thermochromic material is incorporated into the plastic material.

18. The vehicle wheel lug nut attachment or devices as claimed in claim 16 wherein said thermochromic material is provided as a leuco dye which is microencapsulated.

19. The vehicle wheel lug nut attachment or devices as claimed in claim 16 wherein a temperature-caused colour change of said thermochromic material is reversible.

20. The vehicle wheel lug nut attachment of claim 3, wherein each of said openings comprises a series of teeth which are adapted to be fitted around the shoulders of a lug nut, so as to provide said friction fit.

21. The vehicle wheel lug nut locking device of claim 9 wherein a band of thermochromic material is provided between said openings, and provides a temperature gradient that would be representative of the amount of excess heat in the lug nut or lug nuts.

22. A wheel assembly comprising a plurality of wheel lug nuts, and at least one thermochromic attachment, position indicator device or lug nut locking device, as claimed in claim 1 wherein at least one lug nut is operatively thermally connected to said thermochromic attachment, lug nut position indicator device, or lug nut locking device.

23. The wheel assembly as claimed in claim 22 wherein a combination of attachments, position indicator devices or lug nut locking devices, are used, wherein at least one of the wheel lug nuts in the wheel assembly are connected to thermochromic attachments, lug nut position indicator devices, and or lug nut locking devices.

24. A wheel lug nut position indicator system, comprising placing one or a plurality of wheel lug nut position indicator devices on a plurality of lug nuts on a wheel assembly, wherein at least one of the lug nut position indicator device is a thermochromic lug nut position indicator device of the type described in claim 4.

25. A method for reducing the amount of rotational movement of at least one lug nut on a wheel assembly, by placing a thermochromic lug nut locking device as claimed in claim 8, on at least one lug nut.

27. The method as claimed in claim 25 wherein, wherein said thermochromic lug nut locking device comprises a locking member having a first planar section at one end of the locking member, a second planar section at an opposite end of the locking member, and a flexible, resilient connection section between said first and second planar sections, which connection section allows relative movement of the first and second planar sections, and wherein each of said first and second planar sections has an opening configured to be friction fitted around separate lug nuts, and wherein, all or a portion of said locking member includes a thermochromic material which is thermally connected to one or more lug nuts.

28. The method as claimed in claim 25, wherein all of the lug nuts of a wheel assembly are each connected to lug nut locking devices.
